(19) United States
(12) Patent Application Publication
(10) Pub. No.: US 2025/0019174 A1
(43) Pub. Date: Jan. 16, 2025

(54) METHOD FOR DELIVERING GOODS TO A CUSTOMER UTILIZING OPTICAL CHARACTER RECOGNITION

(71) Applicant: Autostore Technology AS, Nedre Vats (NO)

(72) Inventor: Ivar Fjeldheim, Haugesund (NO)

(73) Assignee: Autostore Technology AS, Nedre Vats (NO)

(21) Appl. No.: 18/714,425

(22) PCT Filed: Dec. 12, 2022
(86) PCT No.: PCT/EP2022/085290

§ 371 Date: May 29, 2024

(30) Foreign Application Priority Data
Dec. 13, 2021 (NO) 20211496

(51) Int. Cl. B65G 1/137; G06Q 10/083

(52) U.S. Cl. CPC B65G 1/1375; G06Q 10/083

(57) ABSTRACT

A method and system relate to the logistics of product delivery in the situation where a customer picks up preordered goods directly from a warehouse facility, which includes an automated storage and retrieval system, arriving at the facility in an automobile. The system includes one or more cameras equipped with optical character recognition capability. A first camera reading makes a first, initial recognition of the license plate number of a customer's vehicle upon arrival at the property of the warehouse facility. The initial reading triggers the initiation of a sequence of steps in the consolidation and transport of the delivery package to a customer pickup bay, which may include an automated pickup door. A second camera reading makes a second recognition of the license plate when the customer arrives at a particular parking space adjacent to a specific pickup bay and communicates this information to the control system of the automated storage and retrieval system.

### FIELD OF THE INVENTION

The present invention relates to an automated storage and retrieval system for storage and retrieval of containers and goods stored in containers, in particular to a method for improving a time-sensitive delivery of goods from such a system to a customer.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access/grid openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

### Delivery of Goods to Customers

Goods that are stored in systems described above in some instances are goods that ultimately will be delivered to a customer. In many automated systems of the type described above, the goods will be retrieved from the containers of the system, placed in shipping packages that are later sent out for delivery to a consumer. Where a customer has purchased more than one type of product, the goods will be consolidated into the delivery package, often at station staffed by an employee whose job it is to retrieve the various goods and pack them together into a consolidated delivery package.

In some applications, it is contemplated that a customer will pick up a package of goods directly from a warehouse facility comprising an automated storage and retrieval system as described above. In many such instances the customer may purchase the goods remotely, for example via an Internet website, a mobile device application or a dedicated order terminal. Depending on the nature of the goods, the pickup of the goods by the customer may be time sensitive. For example, in the case of groceries, some products purchased by the customer may be temperature sensitive goods such as refrigerated or frozen goods. In such a case, the length of time between the packing of the consolidated delivery package and the pickup by the customer is critical, as the quality of the goods can rapidly deteriorate.

In the context of an automated storage and retrieval system as described above, frozen or refrigerated goods may be stored in an insulated, temperature controlled section of the framework structure where a number of storage columns in the temperature controlled section hold containers filled with refrigerated or frozen goods. In another embodiment of an automated storage and retrieval system, temperature sensitive goods may be stored in a dedicated storage tower such as described in WO2021/198170.

There is a need therefore for a method that improves the logistics of packing and delivering such goods for direct pickup by the consumer at a facility equipped with an automated storage and retrieval system.

### Optical Character Recognition

It is well known to use automated cameras to read the license plates of vehicles for various purposes. Examples include automatic payment of road tolls, deducting parking fees or opening ports at parking garages and the like. The term “automated cameras” should be understood to encompass arrangements where the optical character recognition capability is provided by a computing device in communication with the camera.

### SUMMARY OF THE INVENTION

The present invention is set forth and characterized in the independent claims, while the dependent claims describe other characteristics of the invention.

According to one aspect, the present invention provides a method whereby the logistics of product delivery is improved in the situation where a customer picks up preordered goods directly from the warehouse facility, arriving at the facility in an automobile. According to this aspect, the customer's order is associated with the license plate number of the customer's automobile. This may be accomplished at the time of the order or may be registered ahead of time in a customer's personal profile with the vendor.

One or more cameras equipped with optical character recognition capability are provided. A first camera reading makes a first, initial recognition of the license plate number of a customer's vehicle upon arrival at the property of the warehouse facility. The initial reading triggers the initiation of a sequence of steps in the consolidation and transport of the delivery package to a customer pickup bay, which may include an automated pickup door. A second camera reading makes a second recognition of the license plate when the customer arrives at a particular parking space adjacent to a specific pickup bay and communicates this information to the control system of the automated storage and retrieval system. It should be understood that a single camera, with sufficiently wide view and resolution could perform the function of a plurality of cameras if viewing conditions were to permit. Alternatively, the first and second camera readings may be performed by separate cameras. The control system then directs the transport of the delivery package to the correct pickup bay. The time difference between the initial reading and the second reading is utilized by the system to improve the efficiency of a packaging and delivery routine determined by the control system of the automated storage and retrieval system of the facility.

According to one aspect, the invention is a method, comprising:
a. providing a warehouse facility (600), located on or adjacent to a warehouse property (606), within which warehouse facility is arranged an automated storage and retrieval system (1) comprising a storage grid (104) provided by a framework structure (100), the framework structure (100) comprising a rail system (108) arranged at an upper level of the framework structure, the rail system comprising a first set of parallel rails (110) arranged in a horizontal plane (P) and extending in a first direction (X), and a second set of parallel rails (111) arranged in the horizontal plane (P) and extending in a second direction (Y) which is orthogonal to the first direction (X), which first and second sets of rails (110, 111) form a grid pattern in the horizontal plane (P) comprising a plurality of adjacent access openings/grid cells (112), and the storage grid defining a plurality of storage columns (105), each storage column being arranged to store a respective stack (107) of storage containers (106), wherein the storage columns (105) are located beneath the rail system (108) and wherein each storage column (105) is located vertically below a respective access opening/grid cell (112);
wherein the automated storage and retrieval system further comprises
   i. a plurality of container handling vehicles (201/301) that operate on the rail system (108) for collecting and returning storage containers (106) to and from storage columns (105),
   ii. a control system (500) for monitoring and controlling the automated grid storage and retrieval system,
   iii. an access station (614) where storage containers (106) are presented to an operator (616) for removal of goods from the storage containers (106) and packing into a consolidated delivery package (601) intended for delivery to the customer,
   iv. one or more intermediate storage areas (603) arranged for temporary placement of consolidated delivery packages awaiting delivery to the customer,
b. the warehouse facility and/or property being provided with
   i. one or more customer pickup bays (604), each pickup bay being in conjunction with a corresponding parking space (611) for a customer automobile (602), said customer pickup bay being equipped with an automated access door (605), said customer pickup bay being in operative communication with the intermediate storage area (603) whereby consolidated delivery packages are transported from the intermediate storage area to the customer pickup bay via a conveyor belt (618) or a container handling vehicle (201/301) or a combination thereof,
   ii. one or more cameras (610) providing optical character recognition capability, able to read and recognize a license plate number (612) of the automobile (602), one camera reading occurring at a first location (608) on the property (606) and another camera reading occurring at the one or more customer pickup bays (604),
wherein the method further comprises the steps of
c. receiving an order from a customer for goods stored in the warehouse facility,
d. associating the license plate number of the customer's vehicle with the order,
e. scheduling an estimated pickup time for when the customer will pick up the goods,
f. calculating a delivery routine using the control system (500), said routine comprising assembling the goods into a consolidated delivery package, placing the consolidated delivery package in the intermediate storage area, where the consolidated delivery package will await transport from the intermediate storage area to the automated access door of a customer pickup bay (604),
g. causing a camera (610) to perform an initial reading of the license plate number of the customer's automobile at the first location (608)
h. initiating a portion of the delivery routine based upon the initial reading of the license plate number,
i. performing a second reading of the license plate number of the customer's automobile at a particular customer pickup bay (604) at which the customer parks, said second reading communicating the identity of the pickup bay at which the customer parks to the control system (500),
j. completing the delivery routine in response to the second camera reading, by transporting the consolidated delivery package comprising the customer's order to the automated access door (605) at the customer pickup bay (604) where the customer's automobile is parked,
k. opening the automated access door and thereby allowing retrieval of the consolidated delivery package by the customer.

In another aspect the invention comprises the system for implementing the above method.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 illustrates the aspect of the invention regarding cameras equipped with optical character recognition capability, where FIG. 5A shows a camera arranged at an entrance and FIGS. 5B and 5C show different possible arrangements of a customer pickup location also equipped with a camera.

FIG. 6 is a schematic illustration of the layout of the system of the invention within a warehouse.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

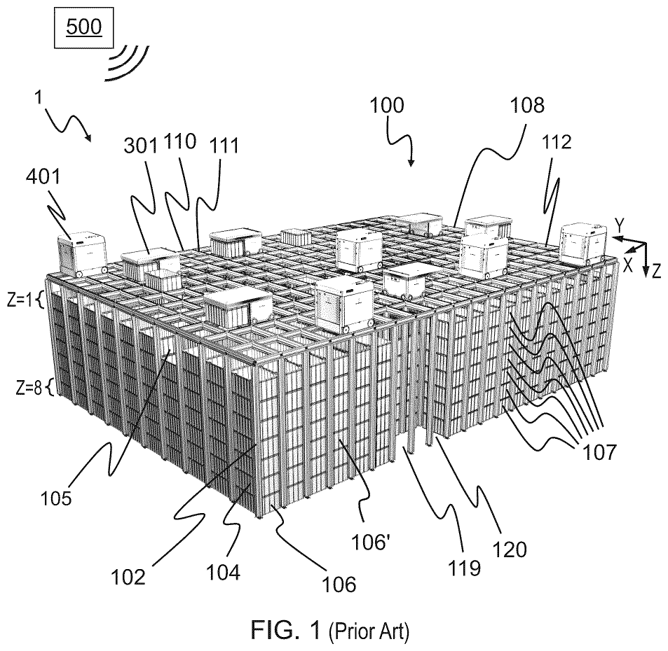

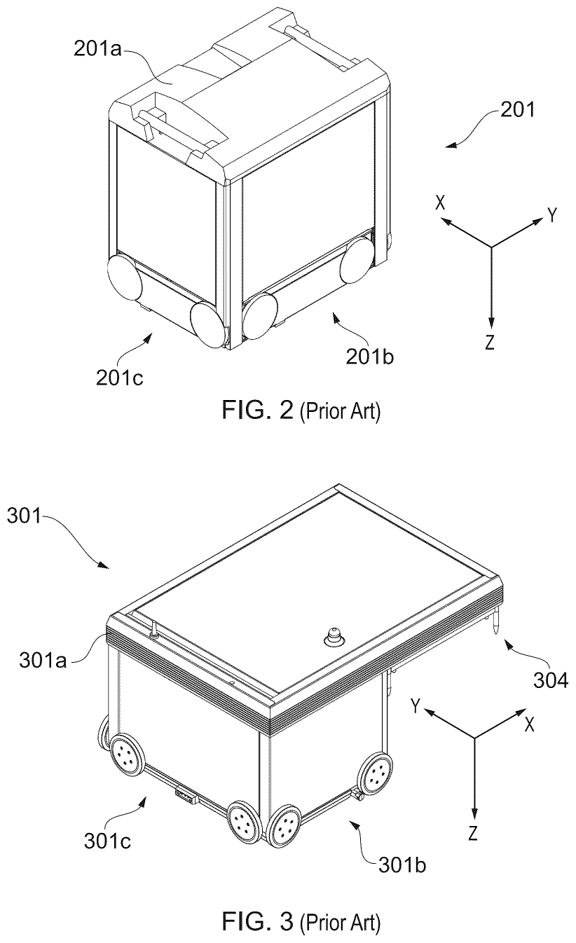

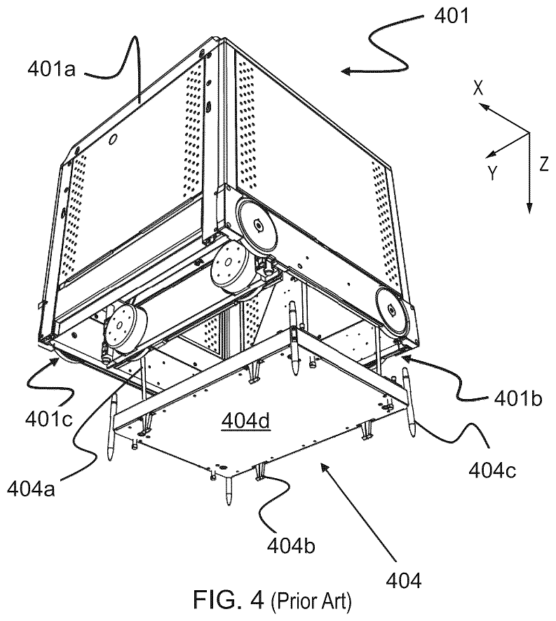

The method of the invention improves the logistics of delivering a delivery package, consolidated from goods stored in storage containers in an automated storage and retrieval system, said system described as follows: The automated storage and retrieval system for use with the invention is arranged as described in the BACKGROUND section of this application and with reference to FIGS. 1-4.

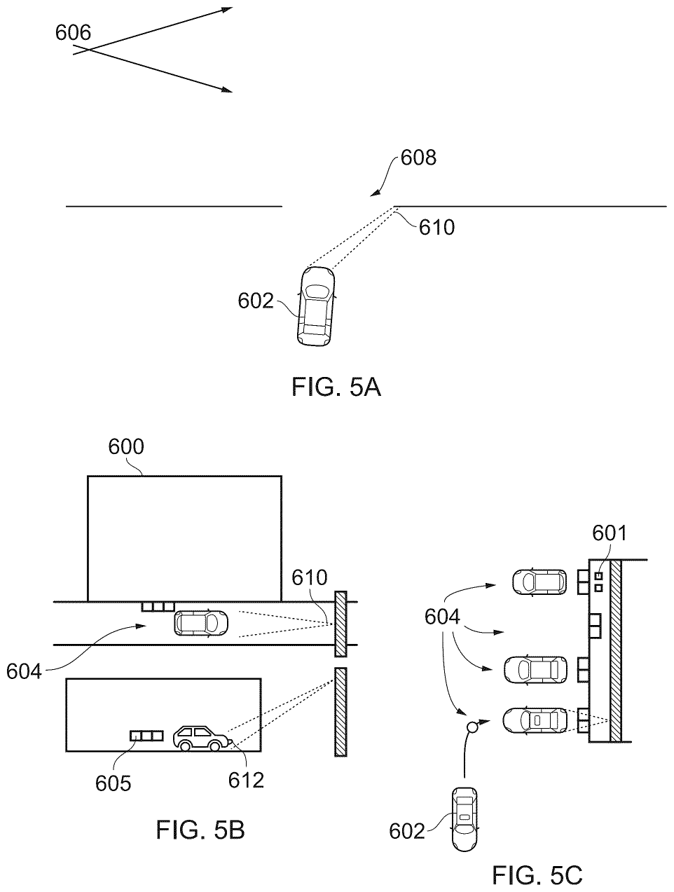

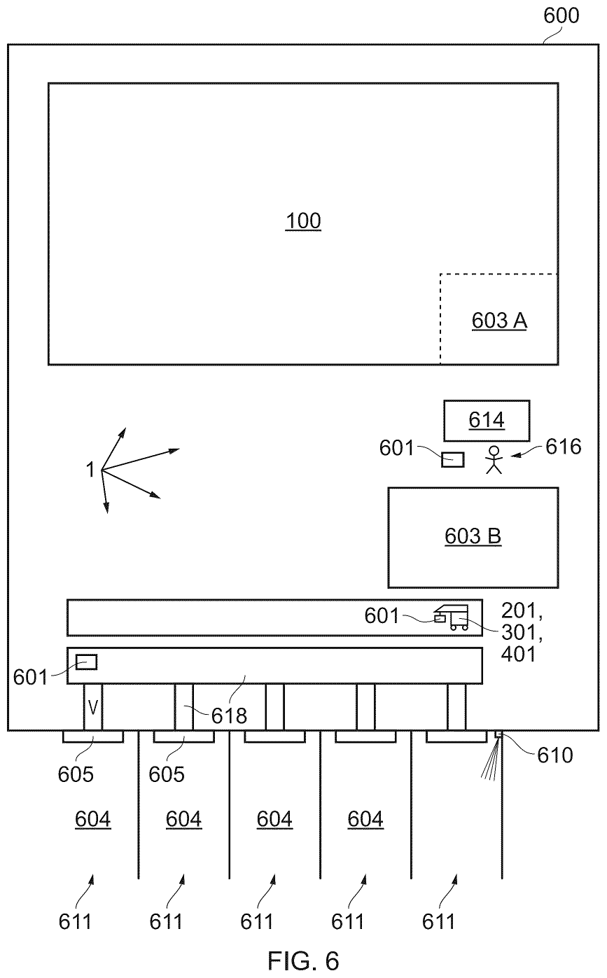

One embodiment of the method of the invention will now be discussed in more detail with reference to FIGS. 5 and 6.

In the preceding description, various features of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

According to one aspect, the present invention provides a method whereby the logistics of product delivery is improved. The method of the invention will be described below in relation to the delivery of groceries, e.g. including temperature sensitive goods, e.g. frozen and refrigerated goods, to a consumer. It should however be understood that the method of the invention is applicable to any goods intended to be picked up directly at a warehouse facility 600, and in particular to any goods that may suffer adverse effects by the passage of time between packing into a consolidated delivery package 601 and retrieval by the customer.

According to another aspect, the method relates to improving the delivery logistics where the consumer arrives at the pickup location in their own automobile 602.

According to the invention, an automated storage and retrieval system 1 as described above is arranged within a warehouse facility 600. An appropriate user interface (not described further herein) allows the customer to purchase goods remotely and to schedule a pickup time for the goods, for example via mobile device or a computer. The scheduled pickup time may be an estimated pickup time and include a time window for the pickup. The scheduled pickup time may also be an immediate pickup time, for example if the customer were to place the order at an order terminal located at the warehouse facility and intend immediate pickup of the goods.

Upon completion of the purchase, the control system 500 of the automated storage and retrieval system 1 compares the nature of the goods purchased with the scheduled pickup time or time window and calculates an optimized packaging and delivery routine for the order, explained in more detail below.

The control system 500 thereafter, at a time dictated by the optimized packaging and delivery routine, instructs the container handling vehicles 201, 301,401 to retrieve the various containers containing the goods of the customer's order and deliver them to an access station 614, where the various goods are collected into the consolidated delivery package 601 by an operator 616. It should be understood that the term “consolidated delivery package” could encompass a single good if for example the customer only orders a single item.

Once the goods have been consolidated into the delivery package, the consolidated delivery package 601 is moved to an intermediate storage area 603, where the consolidated delivery package 601 awaits transport to a customer pickup bay 604, which includes a parking space that is preferably adjacent to an automated access door 605, explained in detail below. The facility may comprise a first intermediate storage area 603A for delivery packages containing room temperature goods, and a separate, second, temperature controlled intermediate storage area 603B for delivery packages that contain temperature sensitive goods. In the event the customer order comprises goods that require refrigeration as well as goods that should avoid refrigeration, the order may be divided into multiple consolidated delivery packages. At a time determined by the control system 500, the consolidated delivery package is transported at the time of delivery to the pickup bay 604, for example by conveyor belt 618 or by one of the container handling vehicles of the system.

The optimized packing and delivery routine mentioned above is calculated by taking into account a plurality of factors, including but not limited to the following:
The length of time between the purchase of the goods and the scheduled delivery time.
The breadth of any delivery time window
The nature of the goods comprising the order, such as whether the order comprises temperature sensitive items
The estimated time required to consolidate the goods into the delivery package, which may include considerations of:
   The location in the stacks of the containers containing the goods of the order
   The physical distances that the container handling vehicles must travel to completely retrieve all of the goods of the order
   The current or expected work demands on the system
   The number of, and effectiveness of the operators of the access stations
   The current or expected availability, or lack thereof, of storage space in the intermediate storage areas

Based upon the applicable factors, the control system may instruct the consolidation process (i.e. delivering containers to the access station for assembly into the consolidated delivery package 601) to begin immediately after the purchase, or may insert a time delay so that the consolidation operation is completed as close to the scheduled delivery time as possible. Where the purchase order contains refrigerated or frozen goods, it is particularly advantageous to assemble the consolidated delivery package as close to the scheduled pickup time as possible to avoid degradation of the goods or to avoid overcrowding in the refrigerated intermediate storage area.

Once the goods have been assembled into the consolidated delivery package, the package is moved to an intermediate storage area 603, which may be a designated section of the framework structure, a separate, dedicated storage tower, or any other appropriate arrangement. At an appropriate time, discussed below, the control system causes the consolidated delivery package to be transported to the customer pickup bay 604, which may be equipped with an automated access door 605.

According to one aspect of the invention, the step in the delivery routine of transporting the consolidated delivery package from the intermediate storage area 603 to the customer pickup bay 604 is controlled in response to the physical arrival of the customer, in an automobile 602, at the property 606 of warehouse facility.

According to this aspect, the warehouse facility 600 is arranged to have the following, or similar physical layout: the warehouse facility 600 will have the customer pickup bay 604 located on property 606 which is accessible by automobile. The pickup area will preferably have a designated entrance 608. Depending upon the size of the facility, this may be a gated entrance at a significant distance from the warehouse itself. The warehouse facility will be equipped with a plurality of customer pickup bays 604 preferably adjacent to automated access doors 605. The pickup bays may for example be marked parking spaces 611. The access doors will preferably be automated, such that they open automatically to allow the customer to access the delivery package located behind said door.

Further according to another aspect, the system comprises one or more, preferably at least two, cameras 610 providing optical character recognition capability, allowing the cameras to read and recognize a license plate number 612 of automobiles passing in the cameras' field of view. According to this aspect, the customer will have associated his or her license plate number 612 with the order. This may for example be the result of the customer having a pre-recorded customer profile including his or her license plate number.

At or near the scheduled delivery time, the customer will arrive at the property 606 of the warehouse facility 600 in his or her automobile 602. As the customer approaches or passes the entrance 608 to the property, a first camera 610 makes an initial reading of the license plate number and identifies the order associated with the customer. Upon this initial reading, the control system 500 initiates the process of retrieving and transporting the consolidated delivery package 601 from the intermediate storage area 603 to the pickup bay 604 (or causing the actual start of the consolidation operation itself or any other stage in the packing and delivery process, if time appropriate). The transport operation of the delivery process thus gets a “head start” while the customer is driving through the property looking for a parking space at one of several customer pickup bays 604. Such a “head start” provides valuable time optimization of the system, which is particularly important in the case of temperature sensitive goods, as well as minimizing the waiting time for the customer at the delivery door.

Once the customer arrives at one of possibly many parking spaces in conjunction with one of possibly many pickup bays 604 (each with an associated access door), a second camera 610 reads the license plate of the automobile and registers the particular pickup bay where the customer's automobile is located. The customer's actual location is communicated to the control system 500, which directs the now “on route” delivery package to be transported to the correct access door, which thereafter automatically opens allowing the customer to retrieve the package. This operation thus provides a more efficient and convenient delivery experience for the customer by minimizing the length of time the customer must wait for the delivery package to arrive at the correct door.

### LIST OF REFERENCE NUMBERS

### Prior Art (FIGS. 1-4):

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

### FIGS. 5-6

600 Warehouse facility
601 Consolidated delivery package
602 Customer automobile
603 Intermediate storage area
603A first Intermediate storage area
603B second Intermediate storage area
604 customer pickup bay
605 automated access door
606 property of the warehouse facility
608 designated entrance
610 Camera
611 parking space
612 license plate number
614 access station
616 operator
618 conveyor belt

1. A method for delivering products to a customer, comprising:
a. providing a warehouse facility, located on or adjacent to a warehouse property, within which warehouse facility is arranged an automated storage and retrieval system comprising a storage grid provided by a framework structure, the framework structure comprising a rail system arranged at an upper level of the framework structure, the rail system comprising a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid cells, and the storage grid defining a plurality of storage columns, each storage column being arranged to store a respective stack of storage containers, wherein the storage columns are located beneath the rail system and wherein each storage column is located vertically below a respective access opening/grid cell;
wherein the automated storage and retrieval system comprises:
i. a plurality of container handling vehicles that operate on the rail system for collecting and returning storage containers to and from storage columns,
ii. a control system for monitoring and controlling the automated grid storage and retrieval system,
iii. an access station where storage containers are presented to an operator for removal of goods from the storage containers and packing into a consolidated delivery package intended for delivery to the customer,
iv. one or more intermediate storage areas arranged for temporary placement of consolidated delivery packages awaiting delivery to the customer,
b. the warehouse facility and/or property being provided with:
i. one or more customer pickup bays, each pickup bay being in conjunction with a corresponding parking space for a customer automobile, said customer pickup bay being equipped with an automated access door, said customer pickup bay being in operative communication with the intermediate storage area whereby consolidated delivery packages are transported from the intermediate storage area to the customer pickup bay via a conveyor belt or a container handling vehicle or a combination thereof,
ii. one or more cameras providing optical character recognition capability, able to read and recognize a license plate number of the automobile, one camera reading occurring at a first location on the property and another camera reading occurring at the one or more customer pickup bays,
wherein the method further comprises:
c. receiving an order from a customer for goods stored in the warehouse facility,
d. associating the license plate number of the customer's vehicle with the order,
e. scheduling an estimated pickup time for when the customer will pick up the goods,
f. calculating a delivery routine using the control system, said routine comprising assembling the goods into a consolidated delivery package, placing the consolidated delivery package in the intermediate storage area, where the consolidated delivery package will await transport from the intermediate storage area to the automated access door of a customer pickup bay,
g. causing a camera to perform an initial reading of the license plate number of the customer's automobile at the first location,
h. initiating a portion of the delivery routine based upon the initial reading of the license plate number,
i. performing a second reading of the license plate number of the customer's automobile at a particular customer pickup bay at which the customer parks, said second reading communicating the identity of the pickup bay at which the customer parks to the control system,
j. completing the delivery routine in response to the second camera reading, by transporting the consolidated delivery package comprising the customer's order to the automated access door at the customer pickup bay where the customer's automobile is parked,
k. opening the automated access door and thereby allowing retrieval of the consolidated delivery package by the customer.

2. The method according to claim 1, wherein the customer order comprises refrigerated or frozen goods.

3. The method according to claim 1, wherein the intermediate storage area is temperature controlled.

4. The method according to claim 1, wherein the delivery routine is calculated based upon one more of the following factors:
a. The temperature-sensitive nature of the goods of the order,
b. The location of the goods in the storage columns of the automated storage and retrieval system,
c. The estimated time required to consolidate the order,
d. The storage capacity of the intermediate storage area.

5. The method according to claim 1, wherein a first camera performs the initial and a second camera performs the second reading.

6. A system for delivering goods to a customer, comprising:
a. a warehouse facility, located on or adjacent to a warehouse property, within which warehouse facility is arranged an automated storage and retrieval system comprising a storage grid provided by a framework structure, the framework structure comprising a rail system arranged at an upper level of the framework structure, the rail system comprising a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid cells, and the storage grid defining a plurality of storage columns, each storage column being arranged to store a respective stack of storage containers, wherein the storage columns are located beneath the rail system and wherein each storage column is located vertically below a respective access opening/grid cell;
wherein the automated storage and retrieval system comprises:
i. a plurality of container handling vehicles that operate on the rail system for collecting and returning storage containers to and from storage columns,
ii. a control system for monitoring and controlling the automated grid storage and retrieval system,
iii. an access station where storage containers are presented to an operator for removal of goods from the storage containers and packing into a consolidated delivery package intended for delivery to the customer,
iv. one or more intermediate storage areas arranged for temporary placement of consolidated delivery packages awaiting delivery to the customer,
b. the warehouse facility and/or property being provided with:
i. one or more customer pickup bays, each pickup bay being in conjunction with a corresponding parking space for a customer automobile, said customer pickup bay being equipped with an automated access door, said customer pickup bay being in operative communication with the intermediate storage area whereby consolidated delivery packages are transported from the intermediate storage area to the customer pickup bay via a conveyor belt or a container handling vehicle or a combination thereof,
ii. one or more cameras providing optical character recognition capability, able to read and recognize a license plate number of the automobile, one camera reading occurring at a first location on the property and another camera reading occurring at the one or more customer pickup bays,
wherein the system further comprises:
c. means for receiving an order from a customer for goods stored in the warehouse facility,
d. means for associating the license plate number of the customer's vehicle with the order,
e. means for scheduling an estimated pickup time for when the customer will pick up the goods,
f. means for calculating a delivery routine using the control system, said routine comprising assembling the goods into a consolidated delivery package, placing the consolidated delivery package in the intermediate storage area, where the consolidated delivery package will await transport from the intermediate storage area to the automated access door of a customer pickup bay,
g. a camera to perform an initial reading of the license plate number of the customer's automobile at the first location,
h. means for initiating a portion of the delivery routine based upon the initial reading of the license plate number,
i. a camera to perform a second reading of the license plate number of the customer's automobile at a particular customer pickup bay at which the customer parks, said second reading communicating the identity of the pickup bay at which the customer parks to the control system,
j. means for completing the delivery routine in response to the second camera reading, by transporting the consolidated delivery package comprising the customer's order to the automated access door at the customer pickup bay where the customer's automobile is parked,
k. means for opening the automated access door and thereby allowing retrieval of the consolidated delivery package by the customer.
